(19) United States
(12) Patent Application Publication
(10) Pub. No.: US 2021/0200824 A1
(43) Pub. Date: Jul. 1, 2021

(54) METHOD AND APPARATUS FOR PERSONALIZING CONTENT RECOMMENDATION MODEL

(71) Applicant: Samsung Electronics Co., Ltd., Suwon-si (KR)

(72) Inventors: Junbeom KIM, Suwon-si (KR); Jihyun KIM, Suwon-si (KR); Taehun KIM, Suwon-si (KR); Kimin OH, Suwon-si (KR); Hangyul YI, Suwon-si (KR)

(21) Appl. No.: 17/139,375

(22) Filed: Dec. 31, 2020

(30) Foreign Application Priority Data
Dec. 31, 2019 (KR) 10-2019-0179651

(51) Int. Cl. G06F 16/9535; G06K 9/62

(52) U.S. Cl. CPC G06F 16/9535; G06K 9/6267

(57) ABSTRACT

A method and apparatus for personalizing a content recommendation model are provided. The method includes obtaining a first content recommendation model used to recommend content to a user of the electronic device, personalizing the first content recommendation model based on a content use history of the user, receiving a second content recommendation model from a server, receiving a personalization model for personalizing the second content recommendation model from the server, personalizing the second content recommendation model by using input/output data of the personalized first content recommendation model and the personalization model, and providing a content recommendation service to the user by using the personalized second content recommendation model.

### CROSS-REFERENCE TO RELATED APPLICATION(S)

This application is based on and claims priority under 35 U.S.C. § 119(a) of a Korean patent application number 10-2019-0179651, filed on Dec. 31, 2019, in the Korean Intellectual Property Office, the disclosure of which is incorporated by reference herein in its entirety.

### BACKGROUND

### 1. Field

The disclosure relates to a method and apparatus for personalizing a content recommendation model.

### 2. Description of Related Art

Recently, a service for providing content to a mobile communication terminal through wireless Internet has become commonplace, and the content provided to the mobile communication terminal may be of various types such as image content, music content, video content, game content, real-time information content, etc.

A content recommendation scheme may include a customized recommendation scheme using preferred genre information and preferred category information that are input by each user, or a purchase history of each user, etc., and in particular, recently, a machine-learning based content recommendation scheme has been used in which, through learning based on a user's use history, a recognition rate may be improved as usage increases, and the user's preference may be accurately understood.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and apparatus for personalizing a content recommendation model received from a server, based on a user's content use history.

Additional aspects will be set forth in part in the description which follows and, in part, will be apparent from the description, or may be learned by practice of the presented embodiments.

In accordance with an aspect of the disclosure, a method, performed by an electronic device, of personalizing a content recommendation model is provided. The method includes obtaining a first content recommendation model used to recommend content to a user of the electronic device, personalizing the first content recommendation model based on a content use history of the user, receiving a second content recommendation model from a server, receiving a personalization model for personalizing the second content recommendation model from the server, personalizing the second content recommendation model by using input/output data of the personalized first content recommendation model and the personalization model, and providing a content recommendation service to the user by using the personalized second content recommendation model.

In accordance with another aspect of the disclosure, an electronic device that personalizes a content recommendation model is provided. The electronic device includes a memory storing one or more instructions and a processor configured to execute the one or more instructions, in which the processor is further configured to, by executing the one or more instructions, obtain a first content recommendation model used to recommend content to a user of the electronic device, personalize the first content recommendation model based on a content use history of the user, receive a second content recommendation model from a server, receive a personalization model for personalizing the second content recommendation model from the server, personalize the second content recommendation model by using input/output data of the personalized first content recommendation model and the personalization model, and provide a content recommendation service to the user by using the personalized second content recommendation model.

In accordance with another aspect of the disclosure, a computer program product is provided. The computer program product includes a non-transitory computer-readable recording medium having recorded thereon a program for executing the method according to the embodiment of the disclosure on a computer.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of a system for providing a content recommendation service, according to an embodiment of the disclosure;

FIG. 2 is a flowchart illustrating a method, performed by an electronic device, of personalizing a content recommendation model, according to an embodiment of the disclosure;

FIG. 3 is a flowchart illustrating a method, performed by an electronic device, of personalizing a content recommendation model by using a personalization model, according to an embodiment of the disclosure;

FIG. 4 illustrates a method, performed by an electronic device, of personalizing a content recommendation model based on a content use history, according to an embodiment of the disclosure;

FIG. 5 illustrates a method, performed by an electronic device, of personalizing a content recommendation model based on weight data obtained from a personalization model, according to an embodiment of the disclosure;

FIG. 6 illustrates a method, performed by a server, of generating a personalization model, according to an embodiment of the disclosure;

FIG. 7 illustrates a method, performed by a server, of generating a personalization model, according to an embodiment of the disclosure;

FIG. 8 is a block diagram of an electronic device according to an embodiment of the disclosure; and

FIG. 9 is a block diagram of a server according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the description of the embodiments, when a part is connected to another part, the part is not only directly connected to another part but also electrically connected to another part with another device intervening in them. When it is assumed that a certain part includes a certain component, the term “including” means that a corresponding component may further include other components unless a specific meaning opposed to the corresponding component is written.

A function related to AI according to the disclosure is performed through a processor and a memory. The processor may include one processor or a plurality of processors. In this case, one processor or a plurality of processors may include a general-purpose processor such as a central processing unit (CPU), an application processor (AP), a digital signal processor (DSP), etc., a graphic-dedicated processor such as a GPU, a vision processing unit (VPU), etc., and an AI-dedicated processor such as a neural processing Unit (NPU). One processor or a plurality of processors may control data to be processed according to a predefined operation rule or AI model stored in the memory. When one processor or a plurality of processors include an AI-dedicated processor, the AI-dedicated processor may be designed as a hardware structure specialized for processing a specific artificial intelligence (AI) model.

Throughout the disclosure, the expression “at least one of a, b or c” indicates only a, only b, only c, both a and b, both a and c, both b and c, all of a, b, and c, or variations thereof.

The predefined operation rule or AI model may be made through training. Herein, when the predefined operation rule or AI model is made through training, it may mean that a basic AI model is trained based on a learning algorithm by using multiple training data, such that the predefined operation rule or AI model set to execute desired characteristics (or purpose) is made. Such training may be performed by a device on which AI according to the disclosure is implemented or by a separate server and/or a system. Examples of a learning algorithm may include, but not limited to, supervised learning, unsupervised learning, semi-supervised learning, or reinforcement learning.

An AI model may include a plurality of neural network layers. Each of the plurality of neural network layers has a plurality of weight values, and performs a neural network operation through an operation between an operation result of a previous layer and the plurality of weight values. The plurality of weight values of the plurality of neural network layers may be optimized by a training result of the AI model. For example, the plurality of weight values may be updated to reduce or minimize a loss value or a cost value obtained in the AI model during a training process. Examples of the AI neural network may include, but not limited to, a deep neural network (DNN), a convolutional neural network (CNN), a recurrent neural network (RNN), a restricted Boltzmann machine (RBM), a deep belief network (DBN), a bidirectional recurrent deep neural network (BRDNN), and a deep Q-network.

Hereinafter, the disclosure will be described with reference to the accompanying drawings.

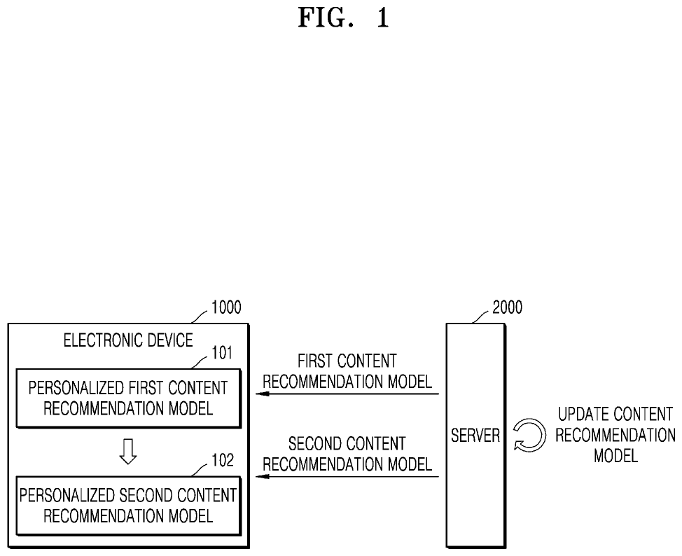

FIG. 1 illustrates an example of a system for providing a content recommendation service according to an embodiment of the disclosure.

Referring to FIG. 1, a system for providing a content recommendation service according to some embodiments of the disclosure may include an electronic device 1000 and a server 2000.

In the disclosure, the electronic device 1000 may provide contents to a user. The electronic device 1000 according to an embodiment of the disclosure refers to an apparatus for recommending contents appropriate for the user by using a content recommendation model, and may include, for example, but not limited to, a smart phone, a personal computer (PC), a laptop computer, a tablet PC, a smart television (TV), a smart speaker, smart audio, etc., and may include any apparatus capable of providing contents to the user.

In the disclosure, contents may include information that may be consumed by the user by being reproduced by the electronic device 100. The contents according to an embodiment of the disclosure may include data including at least one of visual information or auditory information, e.g., but not limited to, a digital newspaper, a book, a record, movies, dramas, etc., and may include any information that may be understood and consumed by the user.

The electronic device 1000 may recommend contents to the user by using the content recommendation model.

In the disclosure, recommendation of the contents may be, as the user selects at least one of contents provided by the electronic device 1000, recommendation of other at least one contents based on at least one of characteristics of the selected contents or a content use history of the user.

Herein, the content recommendation model used by the electronic device 1000 to recommend the contents may be an artificial intelligence (AI) model for recommending contents to the user based on information associated with use of the contents by the user. The content recommendation model may recommend other contents appropriate for the user based on user's selection of the contents.

The electronic device 1000 may use a model including a DNN as a content recommendation model for recommending the contents. For example, the content recommendation model may be trained through a process of outputting recommended content information including at least one recommended contents by using information about the selected contents as an input.

In the disclosure, the deep neural network included in the content recommendation model may include, but is not limited to, at least one of a CNN, an RNN, or a generative adversarial network (GAN), and any type of a deep neural network that may be used for recommendation of contents may be used.

The server 2000 according to some embodiments of the disclosure may generate a content recommendation model, and the electronic device 1000 may recommend contents to the user based on the content recommendation model delivered from the server 2000.

Generation of the content recommendation model, performed by the server 2000, may be performed through learning based on big data using information about the contents as an input and information about at least one recommended contents as an output. Herein, the big data used by the server 2000 for generation of the content recommendation model may be, for example, anonymized data obtained previously to generate the content recommendation model. A big data-based content recommendation system may correspond to a technique known in a technical field associated with content recommendation, and a detailed description of such a content recommendation model generation scheme will be omitted.

The content recommendation model generated by the server 2000 may be distributed to each electronic device 1000 and used to recommend the contents to the user of each electronic device 1000.

Meanwhile, the electronic device 1000 may recommend contents to the user based on the content recommendation model delivered from the server 2000 and personalize the content recommendation model.

In the disclosure, personalization of the content recommendation model may additionally train the content recommendation model to recommend contents optimized for the user as the electronic device 1000 repeatedly recommends the contents to the user based on the content recommendation model. The electronic device 1000 may personalize the content recommendation model to correspond to preference and taste of the user of the electronic device 1000 by repeatedly performing content recommendation by using the content recommendation model delivered from the server 2000.

Referring to FIG. 1, the electronic device 1000 according to some embodiments of the disclosure may receive a first content recommendation model from the server 2000. The electronic device 1000 may recommend other contents in response to user's content selection based on the first content recommendation model delivered from the server 2000.

As other contents are recommended by the electronic device 1000, the user may select desired contents from among the other contents recommended by the electronic device 1000. In this case, as content recommendation based on the first content recommendation model of the electronic device 1000 and content selection of the user are repeated, a personalized first content recommendation model 101 may be obtained.

The server 2000 according to some embodiments of the disclosure may generate a second content recommendation model that is different from the first content recommendation model. In the disclosure, generation of the second content recommendation model that is different from the generated first content recommendation model will be referred to as updating the content recommendation model.

The server 2000 may deliver the first content recommendation model to the electronic device 1000 and update the content recommendation model to generate the second content recommendation model. When the second content recommendation model is generated, the server 200 may deliver the generated second content recommendation model to the electronic device 1000. In this case, for example, the first content recommendation model and the second content recommendation model may have the same network structure or different network structures. When the first content recommendation model and the second content recommendation model have the same network structure or different network structures, input/output data of the first content recommendation model may be changed into a format appropriate for the second content recommendation model.

As the electronic device 1000 performing content recommendation by using the personalized first content recommendation model 101 receives the second content recommendation model from the server 2000, the electronic device 1000 may directly personalize the second recommendation model to obtain a personalized second content recommendation model 102 by using input/output data of the personalized first content recommendation model 101.

The electronic device 1000 according to the disclosure may directly personalize the received second content recommendation model without transmitting use history information regarding user's content selection to the server 2000, thereby protecting user's personal information.

The electronic device 1000 according to the disclosure may personalize the second content recommendation model merely with the input/output data of the personalized first content recommendation model 101 without needing to store huge data regarding a use history, which has been used to personalize the first content recommendation model, thereby protecting user's personal information and improving the efficiency of personalization of the content recommendation model.

Meanwhile, the electronic device 1000 according to the disclosure may use a separate personalization model for directly personalizing the second content recommendation model based on the input/output data of the personalized first content recommendation model. The personalization model may be an AI model that outputs a weight value used to adjust a weight value between layers in the second content recommendation model for personalization of the second content recommendation model. In this case, the personalization model may be generated together with the second content recommendation model by the server 2000.

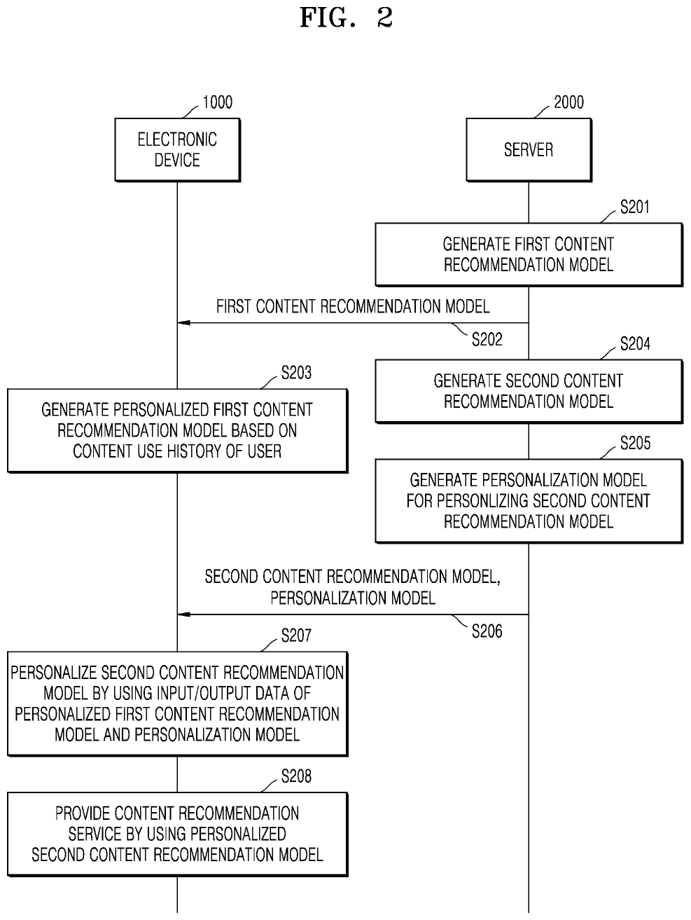

Hereinbelow, based on an embodiment of FIGS. 2 to 7, a detailed method, performed by the electronic device, of personalizing the content recommendation model and a method, performed by the server, of generating a personalization model will be described in detail.

FIG. 2 is a flowchart illustrating a method, performed by an electronic device, of personalizing a content recommendation model, according to an embodiment of the disclosure.

Referring to FIG. 2, the server 2000 according to some embodiments of the disclosure may include generating a first content recommendation model at operation S201. At operation S202, the server 200 may deliver the generated first content recommendation model to the electronic device 1000.

The electronic device 1000 having received the first content recommendation model from the server 2000 may generate the personalized first content recommendation model by personalizing the first content recommendation model based on the user's content use history, at operation S203.

The server 2000 may generate the second content recommendation model at operation S204. The server 2000 may generate a personalization model for personalizing the second content recommendation model at operation S205.

At operation S206, the server 200 may deliver the generated second content recommendation model and the personalization model to the electronic device 1000.

The electronic device 1000 having received the second content recommendation model and the personalization model from the server 2000 may personalize the second content recommendation model by using the input/output data of the personalized first content recommendation model 101 and the personalization model, at operation S207.

At operation 5208, the electronic device 1000 may provide a content recommendation service to the user by using the personalized second content recommendation model 102.

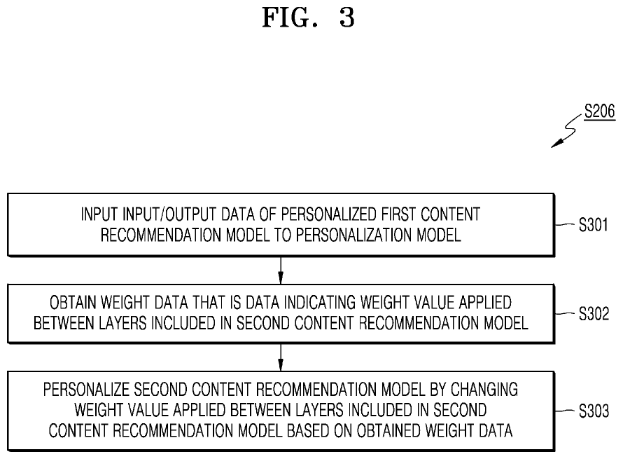

FIG. 3 is a flowchart illustrating a method, performed by an electronic device, of personalizing a content recommendation model by using a personalization model, according to an embodiment of the disclosure.

Referring to FIG. 3, the electronic device 1000 according to some embodiments of the disclosure may personalize the second content recommendation model by using the input/output data of the personalized first content recommendation model and the personalization model, at operation 5205.

In this case, at operation 5301, the electronic device 1000 may input the input/output data of the personalized first content recommendation model 101 to the personalization model.

The electronic device 1000 may obtain weight data, which is data indicating a weight value applied between layers included in the second content recommendation model, at operation 5302.

At operation 5303, the electronic device 1000 may personalize the second content recommendation model by changing the weight value applied between the layers included in the second content recommendation model, based on the obtained weight data.

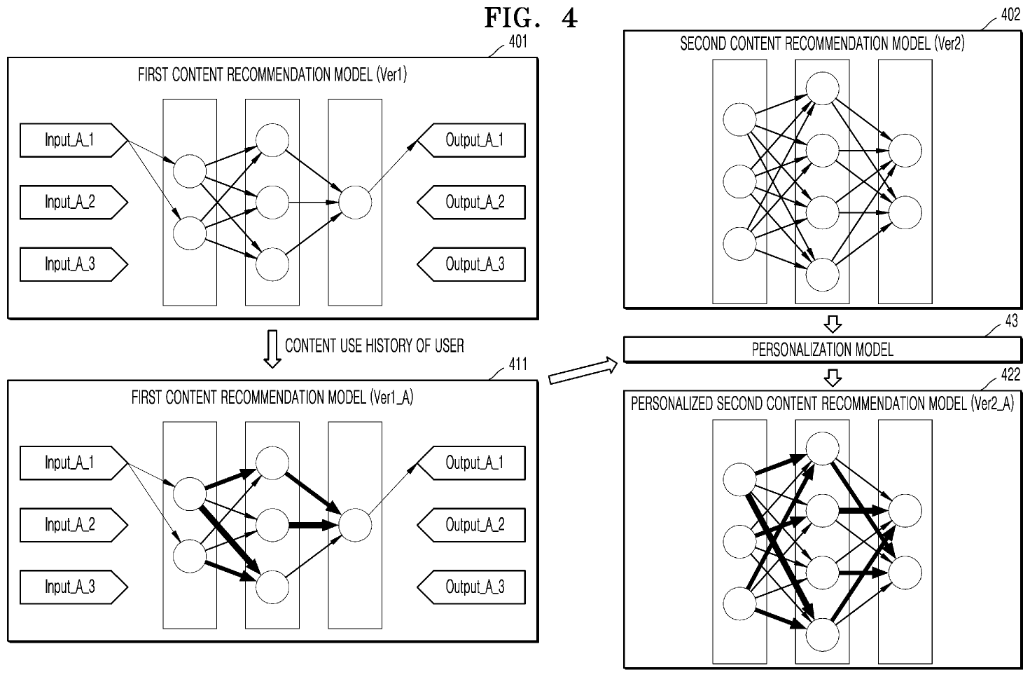

FIG. 4 illustrates a method, performed by an electronic device, of personalizing a content recommendation model based on a content use history, according to an embodiment of the disclosure.

Referring to FIG. 4, the electronic device 1000 according to some embodiments of the disclosure may recommend contents to the user based on a first content recommendation model 401. The electronic device 1000 may output output data Output_A_1, Output_A_2, and Output_A_3 corresponding to content recommendation in response to input data Input_A_1, Input_A_2, and Input_A_3 corresponding to user's content selection, by using the first content recommendation model 401. The input data corresponding to the user's content selection may include, but not limited to, an identification value of contents selected by the user, a genre of the contents, a time and a place when the contents are selected, an identification value of an application executed in the electronic device 1000 when the contents are selected, and so forth.

As the electronic device 1000 recommends contents to the user by outputting the output data Output_A_1, Output_A_2, and Output_A_3, the user may select at least one contents from among recommended contents recommended by the electronic device 1000. For example, the output data output from the first content recommendation model 401 may include, but not limited to, an identification value of the contents. As content selection of the user and content recommendation of the electronic device 1000 are repeated, the first content recommendation model 401 may be personalized, thus obtaining a personalized first content recommendation model 411. The input data and the output data used for content recommendation may be accumulatively stored in the electronic device 1000.

Meanwhile, the server 2000 according to some embodiments of the disclosure may generate a second content recommendation model by updating the first content recommendation model 401. The server 2000 may generate a personalization model 43 corresponding to the second recommendation model, together with generation of the second content recommendation model. The generated second content recommendation model 402 and the personalization model 43 may be delivered to the electronic device 1000. While it has been concisely described above that the server 2000 generates the second content recommendation model 402 by updating the first content recommendation model 401, the disclosure is not limited thereto. The content recommendation model of the server 2000 may be continuously updated using big data for content recommendation, and the content recommendation model prior to update may be referred to as the first content recommendation model 401 and the content recommendation model after update may be referred to as the second content recommendation model 402.

The electronic device 1000 having received the second content recommendation model 402 and the personalization model 43 may obtain input/output data of the personalized first content recommendation model 411 to personalize the second content recommendation model 402. For example, the input/output data of the personalized first content recommendation model 411 may be accumulatively stored in a memory of the electronic device 1000 which may extract input/output data stored in the memory from the memory. In addition, for example, the electronic device 1000 may obtain output data output from the personalized first content recommendation model 411 by inputting input data to the personalized first content recommendation model 411, and obtain a set of the input data and the output data.

The input/output data of the personalized first content recommendation model 411 may be input to the personalization model 43. The personalization model 43 having received the input/output data of the personalized first content recommendation model 411 may obtain information required for generating a personalized second content recommendation model 422 by directly personalizing the second content recommendation model 402 in response to the input input/output data. In this case, for example, data regarding the second content recommendation model 402 may be input to the personalization model 43, together with the input/output data of the personalized first content recommendation model 411. The data regarding the second content recommendation model 402 may include, but not limited to, layers in the second content recommendation model 402 and information about weight values between the layers.

The information used to directly personalize the second content recommendation model 402 may include, for example, weight data which is data indicating a weight value applied between the layers included in the second content recommendation model 402.

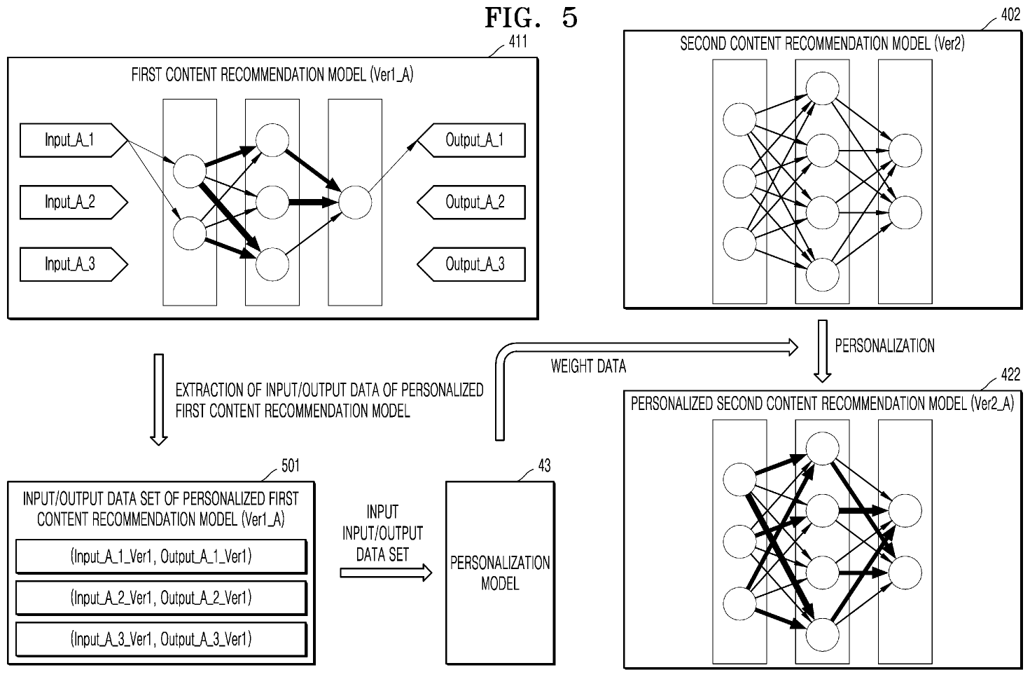

FIG. 5 illustrates a method, performed by an electronic device, of personalizing a content recommendation model based on weight data obtained from a personalization model, according to an embodiment of the disclosure.

Referring to FIG. 5, the electronic device 1000 according to some embodiments of the disclosure may obtain input data input to the personalized first content recommendation model 411 and output data output from the personalized first content recommendation model 411.

The input/output data of the personalized first content recommendation model 411 used by the electronic device 1000 may include, for example, input/output data corresponding to a user's content use history. Herein, the input/output data corresponding to the user's content use history may mean input/output data which has been used to personalize the first content recommendation model 401 into the personalized first content recommendation model 411. Herein, the input/output data corresponding to the user's content use history may be data stored in the memory of the electronic device 1000 in a content recommendation process based on the first content recommendation model 401.

Meanwhile, the input/output data of the personalized first content recommendation model 411 used for the electronic device 1000 to directly personalize the second content recommendation model 402 may be separate input/output data obtained to personalize the second content recommendation model 402 after the electronic device 1000 receives the second content recommendation model 402 from the server 2000. For example, after the electronic device 1000 receives the second content recommendation model 402 from the server 2000 regardless of an existing use history of the user, the electronic device 1000 may input data to the personalized first content recommendation model 411 and obtain data output therefrom, thereby obtaining the input/output data of the personalized first content recommendation model 411. In this case, the electronic device 1000 may not use the input/output data corresponding to the content use history of the user.

Meanwhile, the input/output data of the personalized first content recommendation model 411 used by the electronic device 1000 may include both the input/output data corresponding to the user's content use history and the separate input/output data obtained to personalize the second content recommendation model 402. The input data corresponding to the user's content use history may include, but not limited to, an identification value of contents selected by the user, a genre of the contents, a time and a place when the contents are selected, an identification value of an application executed in the electronic device 1000 when the contents are selected, and so forth. The output data corresponding to the user's content use history may be data output from the personalized first content recommendation model 411 based on the input data corresponding to the user's content use history.

The electronic device 1000 may obtain an input/output data set 501 of the personalized first content recommendation model 411 by combining the input/output data extracted from the personalized first content recommendation model 411.

The electronic device 1000 having obtained the input/output data set 501 of the personalized first content recommendation model 411 may obtain weight data used to directly personalize the second content recommendation model 402 as an output, by inputting the input/output data set 501 of the personalized first content recommendation model 411 to the personalization model 43. In this case, the weight data may be data indicating a weight value applied between the layers included in the second content recommendation model 402.

The electronic device 1000 may obtain the weight data from the input/output data set 501 of the personalized first content recommendation model 411 through the personalization model 43 and directly control the weight value applied between the layers included in the second content recommendation model 402 based on the obtained weight data, thereby generating the personalized second content recommendation model 422.

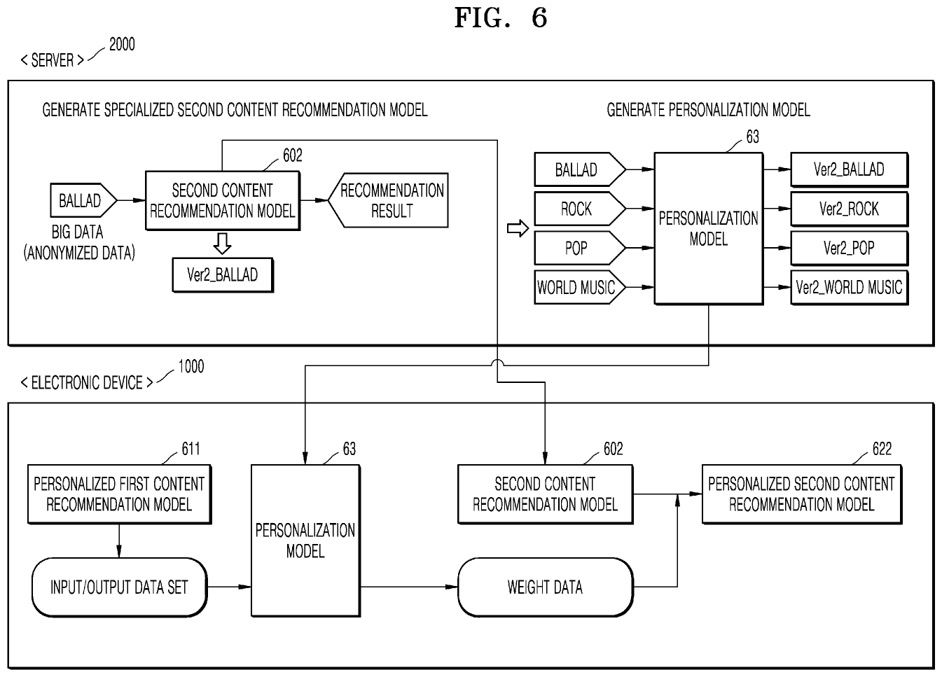

FIG. 6 illustrates a method, performed by a server, of generating a personalization model, according to an embodiment of the disclosure.

The server 2000 according to some embodiments of the disclosure may generate a personalization model 63 based on a plurality of pieces of input data classified for each specific content category and a plurality of second content recommendation models 602 specialized for each specific content category to correspond to the plurality of pieces of classified input data. The content category may be classified based on at least one of a type of contents, an attribute of the contents, or a type of a service provided to the user based on the contents. The type of the contents may include, but not limited to, music movies, pictures, etc. The attribute of the contents may include, but not limited to, a genre of the contents, a running time of the contents, an artist, a producer, a running time, etc. The type of the service may include, but not limited to, a broadcasting service, a music streaming service, and a video streaming service.

The content category may be determined based on similarity between labels of the input data. For example, for a music recommendation service, a user's profile and music content information may be input data. The user's profile may include an age, a gender, a region, etc., and the music content information may include a genre, a composer, a singer, etc. For example, the age, the gender, the region, the genre, etc., may be classified as content categories which may be classified by grouping at least some thereof.

Referring to FIG. 6, the server 2000 may input a plurality of pieces of input data classified for each content category with respect to a previously generated second content recommendation model 602. The server 2000 may input, for example, input data classified as a “ballad” that is a content category related to a music genre, to the second content recommendation model 602, and obtain a recommendation result corresponding to the input data. When a recommendation result corresponding to the input data classified as the ballad is repeatedly obtained, the second content recommendation model 602 may be trained to be specialized for the ballad.

Although not shown in FIG. 6, for respective input data classified as, for example, rock, a pop song, and world music that are content categories related to the music genre, the server 2000 may train the second content recommendation model 602 to be specialized for each of the rock, the pop song, and the world music in the same manner as the input data classified as the ballad.

When the plurality of pieces of input data classified for each content category related to the music genre and the plurality of second content recommendation models 602 specialized to correspond to the plurality of pieces of classified input data are obtained, the server 2000 may use the plurality of pieces of input data classified for each content category related to the music genre as an input value and use a weight value of each of the plurality of specialized second content recommendation models 602 as an output value, thereby training the personalization model 63.

Herein, training of the personalization model 63 may be performed by adjusting a weight value between layers included in the personalization model 63 in a process of outputting a probability of a label of a weight value of the second content recommendation model 602 corresponding to a content category in response to input data classified as the content category. For example, the personalization model 63 may be trained to determine a weight value to be output from the personalization model 63 among weight values between labels in the second content recommendation model 602 specialized using the input/output data corresponding to a specific content category. In this case, a weight value output from the personalization model 63 among the weight values in the specialized second content recommendation model 602 may be a weight value having a high influence upon specialization of the second content recommendation model 602. For example, among the weight values in the specialized second content recommendation model 602, a weight value having a large difference than a weight value of the second content recommendation model 602 before being specialized may be determined as a weight value to be output from the personalization model 63. Alternatively, for example, among the weight values in the specialized second content recommendation model 602, weight values having a high probability that the specialized second content recommendation model 602 outputs an output value corresponding to a specific content category from input data corresponding to the specific content category may be determined as the weight value to be output from the personalization model 63. In this case, the personalization model 63 may be trained using a set of input/output data used for specialization of the second content recommendation model 602 and the weight values of the second content recommendation model 602 specialized based on the input/output set.

As such, the server 2000 according to some embodiments of the disclosure may generate the second content recommendation model 602 and the personalization model 63 corresponding to the generated second content recommendation model 602, thereby allowing the electronic device 1000 to receive the second content recommendation model 602 and the personalization model 63 from the server 2000 and directly personalize the second content recommendation model 602 to obtain the personalized second content recommendation model 622.

Meanwhile, the electronic device 1000 may combine the input data input to the personalized first content recommendation model 611 with the output data output from the personalized first content recommendation model 611, thereby obtaining an input/output data set of the personalized first content recommendation model 611.

The electronic device 1000 having obtained the input/output data set of the personalized first content recommendation model 611 may input the input/output data set of the personalized first content recommendation model 611 to the personalization model 63 received from the server 2000. As the input/output data set of the personalized first content recommendation model 611 is input to the personalization model 63, the electronic device 1000 may obtain weight value used to directly personalize the second content recommendation model 602, i.e., weight data that is data indicating a weight value applied between layers included in the second content recommendation model 602. In this case, the weight data may be data indicating a weight value applied between the layers included in the second content recommendation model 602.

When the weight data is obtained through the personalization model 63, the electronic device 1000 may directly personalize the second content recommendation model by changing the weight value applied between the layers included in the second content recommendation model, based on the obtained weight data.

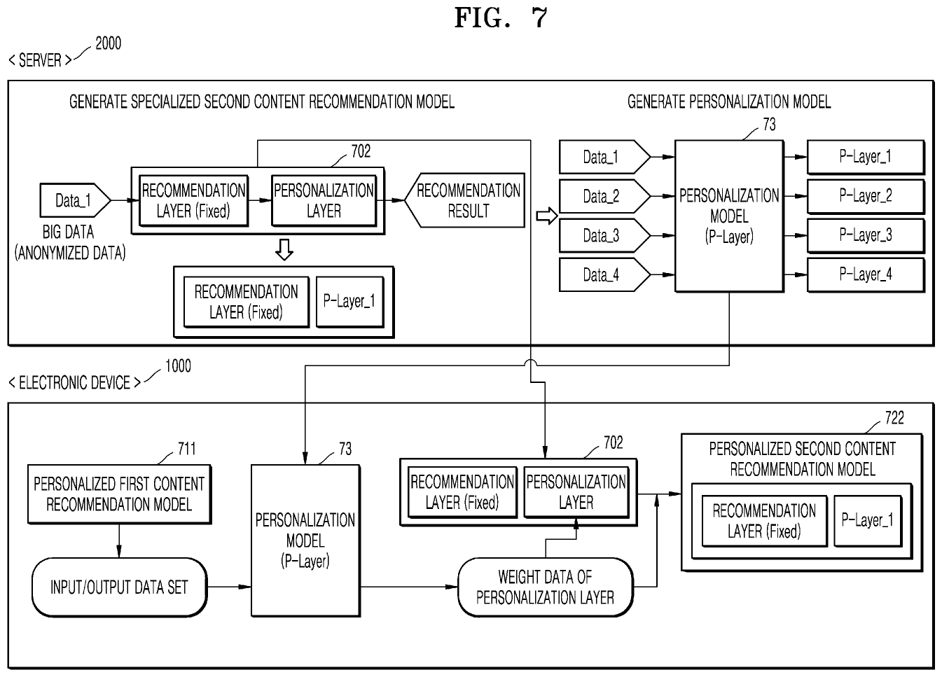

FIG. 7 illustrates a method, performed by a server, of generating a personalization model, according to an embodiment of the disclosure.

Referring to FIGS. 6 and 7, a second content recommendation model 702 generated by the server according to some embodiments of FIG. 7 may include a recommendation layer and a personalization layer, unlike the second content recommendation model 602 generated by the server according to some embodiments of FIG. 6.

The recommendation layer included in the second content recommendation model 702 may be a layer for content recommendation, and the personalization layer included in the second content recommendation model 702 may be a layer for personalizing output data from the recommendation layer. The recommendation layer included in the second content recommendation model 702 may be a layer used for content recommendation, related learning, and recommendation execution. Meanwhile, the personalization layer included in the second content recommendation model 702 may be a layer that is separate from the recommendation layer, and may be a layer used for personalization of the second content recommendation model 702 as well as content recommendation, related learning, and recommendation execution. The personalization layer may be used to personalize the second content recommendation model 702 by changing at least some of weight values output from the recommendation layer. Between the recommendation layer and the personalization layer in the second content recommendation model 702, the personalization layer may be specialized by a specific user, such that a personalized second content recommendation model 722 personalized by the specific user may be generated.

The server 2000 according to some embodiments of the disclosure may generate a personalization model 73 based on a plurality of pieces of input data classified for each user category and a plurality of personalization layers specialized for each user category to correspond to the plurality of pieces of classified input data.

Referring to FIG. 7, the server 2000 may input a plurality of pieces of input data classified for each user category with respect to the previously generated second content recommendation model 702. The server 2000 may input, for example, input data classified as a first user that is the content category related to a user type, to the second content recommendation model 702, and obtain a recommendation result corresponding to the input data. When a recommendation result corresponding to the input data classified as the first user is repeatedly obtained, the personalization layer of the second content recommendation model 702 may be trained to be specialized for the first user.

Although not shown in FIG. 7, for respective input data classified as a second user, a third user, and a fourth user that are content categories related to the user type, the server 2000 may train the personalization layer of the second content recommendation model 702 to be specialized for each of the second user, the third user, and the fourth user in the same manner as the input data classified as the first user.

When the plurality of pieces of input data classified for each content category related to the user type and the plurality of personalization layers specialized to correspond to the plurality of pieces of classified input data are obtained, the server 2000 may use the plurality of pieces of input data classified for each content category related to the user type as an input value and use a weight value of each of the plurality of specialized personalization layers as an output value, thereby training the personalization model 73. Thus, the personalization model 73 may output a weight value of the personalization layer to change at least some of the weight values output from the recommendation layer in the second content recommendation model 702 by using the input data of the second content recommendation model 702 as an input.

Herein, training of the personalization model 73 may be performed by adjusting a weight value between layers included in the personalization model 73 in a process of outputting a genre weight value of the second content recommendation model 702 corresponding to a content category in response to input data classified as the content category.

As such, the server 2000 according to some embodiments of the disclosure may generate the second content recommendation model 702 and the personalization model 73 corresponding to a personalization layer of the generated second content recommendation model 702, thereby allowing the electronic device 1000 to receive the second content recommendation model 702 and the personalization model 73 from the server 2000 and directly personalize the second content recommendation model 702 and at the same time, personalize the second content recommendation model 702 by using relatively less weight data.

Meanwhile, the electronic device 1000 may obtain an input/output data set of a personalized first content recommendation model 711 by combining the input/output data extracted from the personalized first content recommendation model 711.

The electronic device 1000 having obtained the input/output data set of the personalized first content recommendation model 711 may obtain weight data of a personalization layer used to directly personalize the second content recommendation model 702 as an output, by inputting the input/output data set of the personalized first content recommendation model 411 to the personalization model 73 received from the server 2000. The weight data of the personalization layer may be data indicating a weight value applied between personalization layers included in the second content recommendation model 702.

When the weight data is obtained through the personalization model 73, the electronic device 1000 may directly personalize the second content recommendation model 702 by changing the weight value applied between the personalization layers included in the second content recommendation model 702, based on the obtained weight data of the personalization layer.

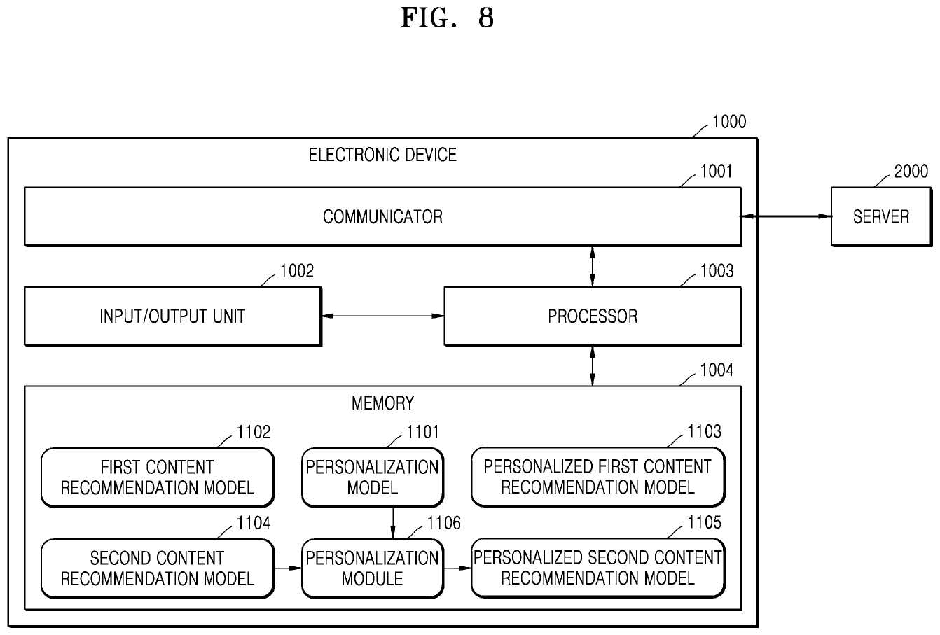

FIG. 8 is a block diagram of an electronic device according to an embodiment of the disclosure.

Referring to FIG. 8, the electronic device 1000 according to some embodiments of the disclosure may include a communication unit (or communicator) 1001, an input/output unit 1002, a processor 1003, and a memory 1004.

The communication unit 1001 may include one or more communication modules for communication with the server 2000. For example, the communication unit 1001 may include at least one of a short-range communicator or a mobile communicator.

The short-range communicator may include, but not limited to, a Bluetooth Low Energy (BLE) communication unit, a near field communication (NFC) unit, a wireless local area network (WLAN) (WiFi) communication unit, a ZigBee communication unit, an infrared Data Association (IrDA) communication unit, a WiFi Direct (WFD) communication unit, an ultra wideband (UWB) communication unit, an Ant+ communication unit, etc.

The mobile communicator may transmit and receive a wireless signal to and from at least one of a base station, an external terminal, or a server over a mobile communication network. Herein, the wireless signal may include various forms of data corresponding to transmission or reception of a voice call signal, a video communication call signal, or a text/multimedia message.

The input/output unit 1002 may receive a user input for controlling an operation of the electronic device 1000 and output data related to contents reproducible in the electronic device 1000 in the form of information that is visibly and/or audibly recognizable by the user.

The input/output unit 1002 may receive a user input by being connected with an input device such as, but not limited to, a keypad, a microphone, a dome switch, a touch pad (a capacitive overlay type, a resistive overlay type, an infrared beam type, a surface acoustic wave type, an integral strain gauge type, a piezoelectric effect type, etc.), a jog wheel, a jog switch, etc.

The input/output unit 1002 may output data related to contents in the form of information that is visibly and/or audibly recognizable by the user by being connected with an output device such as a speaker capable of outputting a signal related to a function (e.g., a call signal receiving sound, a message receiving sound, a notification sound) and reproduced contents in the form of sound, a display that displays information processed in the electronic device 1000 and reproduced contents, etc.

The processor 1003 may control overall operations of the electronic device 1000. For example, the processor 1003 may control overall operations of the communication unit 1001, the input/output unit 1002, and the memory 1004, by executing programs stored in the memory 1004.

The processor 1003 may obtain a first content recommendation model 1102 used to recommend contents to the user of the electronic device 1000. The processor 1003 may personalize the first content recommendation model 1102 based on a user's content use history.

The processor 1003 may receive a second content recommendation model 1104 and a personalization model 1101 for personalizing the second content recommendation model 1104 from the server.

The processor 1003 may personalize the second content recommendation model 1104 by using input/output data of the personalized first content recommendation model 1103 and the personalization model 1101. The processor 1003 may personalize the second content recommendation model 1104 based on the input/output data of the personalized first content recommendation model 1103 and the personalization model 1101 by executing a personalization model 1106 that is a programming module previously stored in the memory 1004.

The processor 1003 may provide a content recommendation service to the user by using a personalized second content recommendation model 1105.

The processor 1003 according to some embodiments of the disclosure may perform, for example, an artificial intelligence (AI) operation. The processor 1003 may be, but not limited to, any one of a central processing unit (CPU), a graphics processing unit (GPU), a neural processing unit (NPU), a field programmable gate array (FPGA), or an application specific integrated circuit (ASIC).

The memory 1004 may store a program for controlling an operation of the electronic device 1000. The memory 1004 may include at least one instruction for controlling an operation of the electronic device 1000. The programs stored in the memory 1004 may be classified into a plurality of modules according to functions thereof.

The memory 1004 may store the personalized first content recommendation model 1103, the second content recommendation model 1104, and the personalization model 1101, which are received from the server 2000.

The memory 1004 may store the personalized first content recommendation model 1103 generated by repeated execution of content recommendation by the electronic device 1000 based on the first content recommendation model 1102.

The memory 1004 may store a personalization module 1106 for personalizing the second content recommendation model 1104 by using input/output data of the personalized first content recommendation model 1103 and the personalization model 1101.

The memory 1004 may store the personalized second content recommendation model 1105 generated by personalization of the second content recommendation model 1104 through the personalization model 1106 by the electronic device 1000.

The memory 1004 may include at least one type of storage medium among, for example, flash memory, a hard disk, a multimedia card micro, card-type memory (e.g., secure digital (SD) or extreme digital (XD) memory), random access memory (RAM), static random access memory (SRAM), read-only memory (ROM), electrically erasable programmable ROM (EEPROM), programmable ROM (PROM), magnetic memory, a magnetic disc, or an optical disc.

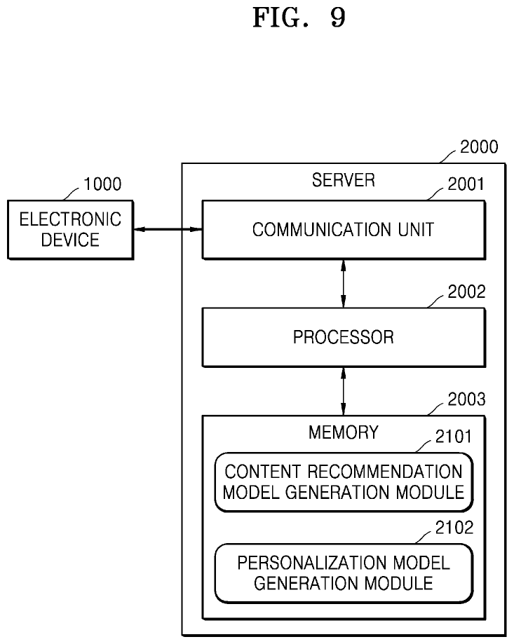

FIG. 9 is a block diagram of a server according to an embodiment of the disclosure.

Referring to FIG. 9, the server 2000 according to some embodiments of the disclosure may include a communication unit 2001, a processor 2002, and a memory 2003.

The communication unit 2001 may include one or more communication modules for communication with the electronic device 1000. For example, the communication unit 2001 may include at least one of a short-range communicator or a mobile communicator.

The short-range communicator may include, but not limited to, a BLE communication unit, an NFC unit, a WLAN (WiFi) communication unit, a ZigBee communication unit, an IrDA communication unit, a WFD communication unit, an UWB communication unit, and an Ant+ communication unit, etc.

The mobile communicator may transmit and receive a radio signal to and from at least one of a base station, an external terminal, or a server over a mobile communication network. Herein, the radio signal may include various forms of data corresponding to transmission/reception of a voice call signal, a video communication call signal, or a text/multimedia message.

The processor 2002 may control overall operations of the server 2000. For example, the processor 2002 may control overall operations of the communication unit 2001 and the memory 2003, by executing programs stored in the memory 2003.

The processor 2002 may generate a content recommendation model to be transmitted to the electronic device 1000.

The processor 2002 may generate a content recommendation model to be transmitted to the electronic device 1000. The processor 2002 may generate a content recommendation model to be transmitted to the electronic device 1000 by executing a content recommendation model generation module 2101 that is a programming module previously stored in the memory 2003. The content recommendation model generated by the processor 2002 may be transmitted to the electronic device 1000 through the communication unit 2001 and thus may be used to provide a content recommendation service of the electronic device 1000.

The processor 2002 may generate a personalization model to be transmitted to the electronic device 1000. The processor 2002 may generate a personalization model to be transmitted to the electronic device 1000 by executing a personalization model generation module 2102 that is a programming module previously stored in the memory 2003. The personalization model generated by the processor 2002 may be transmitted to the electronic device 1000 through the communication unit 2001 and thus may be used for content recommendation model personalization of the electronic device 1000.

The memory 2003 may store a program for controlling an operation of the server 2000. The memory 2003 may include at least one instruction for controlling an operation of the server 2000. The programs stored in the memory 2003 may be classified into a plurality of modules according to functions thereof

The memory 2003 may store the content recommendation model generation module 2101 used to generate the content recommendation model to be transmitted to the electronic device 1000.

The memory 2003 may store the personalization model generation module 2102 used to generate the personalization model to be transmitted to the electronic device 1000.

The memory 2003 may include at least one type of storage medium among, for example, flash memory, a hard disk, a multimedia card micro, card-type memory (e.g., secure digital (SD) or extreme digital (XD) memory), random access memory (RAM), static random access memory (SRAM), read-only memory (ROM), electrically erasable programmable ROM (EEPROM), programmable ROM (PROM), magnetic memory, a magnetic disc, or an optical disc.

Some embodiments of the disclosure may be implemented with a recording medium including a computer-executable instruction such as a computer-executable programming module. A computer-readable recording medium may be an available medium that is accessible by a computer, and includes all of a volatile medium, a non-volatile medium, a separated medium, and a non-separated medium. The computer-readable recording medium may also include a computer storage medium. The computer storage medium includes all of a volatile medium, a non-volatile medium, a separated medium, and a non-separated medium, which is implemented by a method or technique for storing information such as a computer-readable instruction, a data structure, a programming module, or other data.

In addition, the computer-readable storage medium may be provided in the form of a non-transitory storage medium. Wherein, the term ‘non-transitory storage medium’ simply means that the storage medium is a tangible device, and does not include a transitory electrical signal (e.g., an electromagnetic wave), but this term does not differentiate between where data is semi-permanently stored in the storage medium and where the data is temporarily stored in the storage medium. For example, the ‘non-transitory storage medium’ may include a buffer in which data is temporarily stored.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. When distributed online, at least a part of the computer program product (e.g., a downloadable app) may be temporarily generated or at least temporarily stored in the machine-readable storage medium, such as memory of the manufacturer's server, a server of the application store, or a relay server.

In the specification, the term “unit” may be a hardware component like a processor or a circuit, and/or a software component executed by a hardware component like a processor.

Those of ordinary skill in the art to which the disclosure pertains will appreciate that the disclosure may be implemented in different detailed ways without departing from the technical spirit or essential characteristics of the disclosure. Accordingly, the aforementioned embodiments of the disclosure should be construed as being only illustrative, but should not be constructed as being restrictive from all aspects. For example, each element described as a single type may be implemented in a distributed mariner, and likewise, elements described as being distributed may be implemented as a coupled type.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method, performed by an electronic device, of personalizing a content recommendation model, the method comprising:
obtaining a first content recommendation model used to recommend content to a user of the electronic device;
personalizing the first content recommendation model based on a content use history of the user;
receiving a second content recommendation model from a server;
receiving a personalization model for personalizing the second content recommendation model from the server;
personalizing the second content recommendation model by using input/output data of the personalized first content recommendation model and the personalization model; and
providing a content recommendation service to the user by using the personalized second content recommendation model.

2. The method of claim 1, wherein the input/output data of the personalized first content recommendation model comprises input/output data corresponding to the content use history of the user.

3. The method of claim 1, wherein the personalization model is generated based on a plurality of pieces of input data each classified for a specific content category and a plurality of second content recommendation models specialized for each specific content category to correspond to the classified plurality of pieces of input data.

4. The method of claim 3, wherein the personalizing of the second content recommendation model comprises:
inputting the input/output data of the personalized first content recommendation model to the personalization model;
obtaining weight data indicating a weight value applied between personalization layers included in the second content recommendation model; and
personalizing the second content recommendation model by changing the weight value applied between the personalization layers included in the second content recommendation model, based on the obtained weight data of the personalization layer.

5. The method of claim 1,
wherein the second content recommendation model comprises a content recommendation layer and a personalization layer, and
wherein the personalization model is generated based on a plurality of pieces of input data each classified for a specific user category and a plurality of personalization layers specialized for each specific user category to correspond to the classified plurality of pieces of input data.

6. The method of claim 5, wherein the personalizing of the second content recommendation model comprises:
inputting the input/output data of the personalized first content recommendation model to the personalization model;
obtaining weight data of a personalization layer, which is data indicating a weight value applied between personalization layers included in the second content recommendation model; and
personalizing the second content recommendation model by changing the weight value applied between the personalization layers included in the second content recommendation model, based on the obtained weight data of the personalization layer.

7. The method of claim 1, wherein the second content recommendation model comprises a recommendation layer and a personalization layer.

8. The method of claim 7,
wherein the recommendation layer is a fixed layer for at least one of content recommendation, related learning, or recommendation execution, and
wherein the personalization layer is a layer for personalizing output data from the recommendation layer.

9. The method of claim 1, wherein personalization model classifies data as a first user that is a content category related to a user type.

10. The method of claim 9, further comprising training a personalization layer of the second content recommendation model to be specialized for the first user based on a recommendation result corresponding to input data classified as the first user being repeatedly obtained.

11. An electronic device that personalizes a content recommendation model, the electronic device comprising:
a memory storing one or more instructions; and
a processor configured to:
execute the one or more instructions to obtain a first content recommendation model used to recommend content to a user of the electronic device,
personalize the first content recommendation model based on a content use history of the user,
receive a second content recommendation model from a server,
receive a personalization model for personalizing the second content recommendation model from the server,
personalize the second content recommendation model by using input/output data of the personalized first content recommendation model and the personalization model, and
provide a content recommendation service to the user by using the personalized second content recommendation model.

12. The electronic device of claim 11, wherein the input/output data of the personalized first content recommendation model comprises input/output data corresponding to the content use history of the user.

13. The electronic device of claim 11, wherein the personalization model is generated based on a plurality of pieces of input data each classified for a specific content category and a plurality of second content recommendation models specialized for each specific content category to correspond to the classified plurality of pieces of input data.

14. The electronic device of claim 13, wherein the processor is further configured, by executing the one or more instructions, to:
input the input/output data of the personalized first content recommendation model to the personalization model,
obtain weight data that is data indicating a weight value applied between personalization layers included in the second content recommendation model, and
personalize the second content recommendation model by changing the weight value applied between the personalization layers included in the second content recommendation model, based on the obtained weight data of the personalization layer.

15. The electronic device of claim 11,
wherein the second content recommendation model comprises a content recommendation layer and a personalization layer, and
wherein the personalization model is generated based on a plurality of pieces of input data classified for each specific user category and a plurality of personalization layers specialized for each specific user category to correspond to the classified plurality of pieces of input data.

16. The electronic device of claim 15, wherein the processor is further configured, by executing the one or more instructions, to:
input the input/output data of the personalized first content recommendation model to the personalization model,
obtain weight data of a personalization layer, which is data indicating a weight value applied between personalization layers included in the second content recommendation model, and
personalize the second content recommendation model by changing the weight value applied between the personalization layers included in the second content recommendation model, based on the obtained weight data of the personalization layer.

17. A non-transitory computer-readable recording medium having recorded thereon a program for executing a method of personalizing a content recommendation model, the method comprising:
obtaining a first content recommendation model used to recommend content to a user of an electronic device;
personalizing the first content recommendation model based on a content use history of the user;
receiving a second content recommendation model from a server;
receiving a personalization model for personalizing the second content recommendation model from the server;
personalizing the second content recommendation model by using input/output data of the personalized first content recommendation model and the personalization model; and
providing a content recommendation service to the user by using the personalized second content recommendation model.
